(19) United States
(12) Patent Application Publication
(10) Pub. No.: US 2008/0158399 A1
(43) Pub. Date: Jul. 3, 2008

(54) IMAGE SENSOR MODULE, SIGNAL GENERATION DEVICE AND SIGNAL GENERATION METHOD

(76) Inventor: Tomotake HASUO, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/965,340

(22) Filed: Dec. 27, 2007

(30) Foreign Application Priority Data
Dec. 28, 2006 (JP) 2006-354849

(51) Int. Cl. H04N 3/14

(52) U.S. Cl. 348/294

(57) ABSTRACT

An image sensor module according to an example of the invention comprises photoelectric conversion devices, a first terminal to input a line synchronization signal and a resolution information signal, a second terminal to input a clock signal, a first unit which detects the resolution information signal from a signal input from the first terminal based on the clock signal, and a second unit which generates a resolution control signal for setting a resolution indicated by the resolution information signal detected by the first unit and outputs the resolution control signal to the photoelectric conversion devices.

### CROSS-REFERENCE TO RELATED APPLICATIONS

This application is based upon and claims the benefit of priority from prior Japanese Patent Application No. 2006-354849, filed Dec. 28, 2006, the entire contents of which are incorporated herein by reference.

### BACKGROUND OF THE INVENTION

1. Field of the Invention

The present invention relates to an image sensor module. The image sensor module is, for example, CMOS or CCD type.

2. Description of the Related Art

In Document 1 (Jpn. Pat. Appln. KOKAI Publication No. 2005-260656), a plurality of photoelectric conversion devices are multi-mounted. A transmitting terminal of each photoelectric conversion device is connected to a receiving terminal of a photoelectric conversion device which starts an operation next.

A contact image sensor in Document 1 comprises the receiving terminal, the transmitting terminal, a clock input terminal, and a start pulse input terminal. The contact image sensor in Document 1 has a resolution control signal generation unit which generates a resolution control signal by using a clock signal input to the clock input terminal, a start pulse input to the start pulse input terminal, and a resolution information signal input to the receiving terminal.

Accordingly, the contact image sensor in Document 1 need not further have a control terminal used for inputting the resolution information signal.

However, if the resolution control signal generation unit is comprised in the photoelectric conversion device, the size of the photoelectric conversion device is increased. An increased chip size of the photoelectric conversion device causes high price of the photoelectric conversion device and contact image sensor modules.

Further, since a photoelectric conversion unit constituted by an analog circuit inside the photoelectric conversion device and the resolution control signal generation unit constituted by a logic circuit inside the photoelectric conversion device are incorporated onto the same chip according to Document 1, both blocks will be formed by the same process. In such a case, it is difficult to optimize the process for each of the photoelectric conversion unit and resolution control signal generation unit and further, the chip size of the photoelectric conversion device needs to be increased. As a result, the size of a contact image sensor module tends to be large.

If the photoelectric conversion device is of CCD type, timing of a signal supplied to a contact image sensor may have to be changed to switch the resolution. In such a case, with the configuration described in Document 1, the configuration of a system connected to the contact image sensor tends to increase in complexity.

### BRIEF SUMMARY OF THE INVENTION

An image sensor module according to an example of the invention comprises a plurality of photoelectric conversion devices; a signal input terminal to input a line synchronization signal and input a resolution information signal; a clock signal input terminal to input a clock signal; a resolution information detection unit which detects the resolution information signal from a signal which is inputted from the signal input terminal based on the clock signal; and a resolution control signal generation unit which generates a resolution control signal for setting a resolution indicated by the resolution information signal detected by the resolution information detection unit and outputs the resolution control signal to the photoelectric conversion devices.

### BRIEF DESCRIPTION OF THE SEVERAL VIEWS OF THE DRAWING

FIG. 1 is a block diagram showing one example of the configuration of an image sensor module according to the first embodiment.

FIG. 2 is a timing chart showing one example of various signals handled by the image sensor module according to the first embodiment.

FIG. 3 is a flowchart showing one example of the operation of a signal generation unit in the image sensor module according to the first embodiment.

FIG. 4 is a timing chart showing one example of relationship among a resolution information signal, a line synchronization signal, and a clock signal.

FIG. 5 is a block diagram showing one example of the configuration of an image sensor module according to the second embodiment.

FIG. 6 is a timing chart showing one example of various signals handled by the image sensor module according to the second embodiment.

FIG. 7 is a flowchart showing one example of the operation of a signal generation unit in the image sensor module according to the second embodiment.

### DETAILED DESCRIPTION OF THE INVENTION

Each embodiment of the present invention will be described below with reference to the drawings.

### First Embodiment

An image sensor module according to the present embodiment comprises a signal input terminal for inputting a line synchronization signal and when the line synchronization signal is negated, for inputting a resolution information signal, and a clock signal input terminal for inputting a clock signal. The image sensor module generates a start pulse, a resolution control signal (resolution setting signal) and an image output clock based on the resolution information signal and line synchronization signal which is inputted from the signal input terminal and the clock signal which is inputted from the clock signal input terminal.

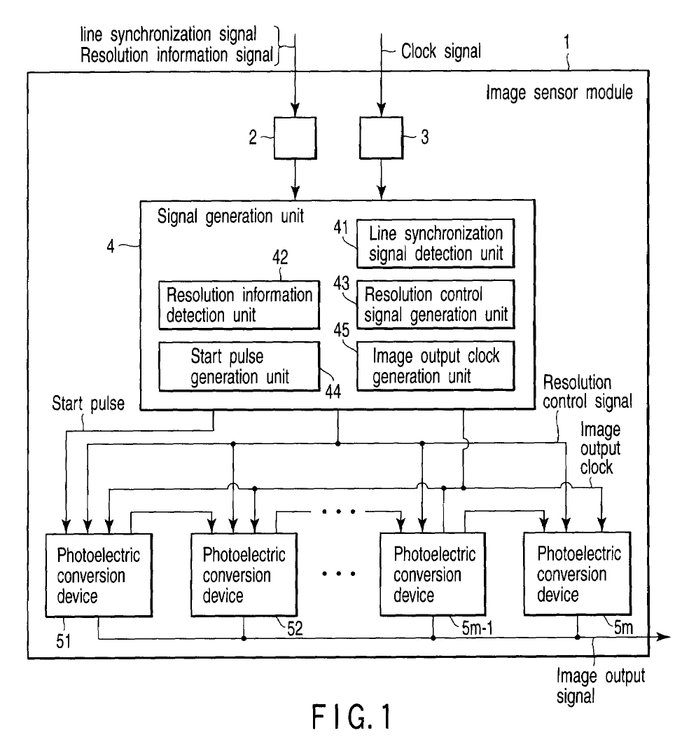

FIG. 1 is a block diagram showing one example of the configuration of the image sensor module according to the present embodiment. An image sensor module 1 is, for example, a contact image sensor module of CMOS type.

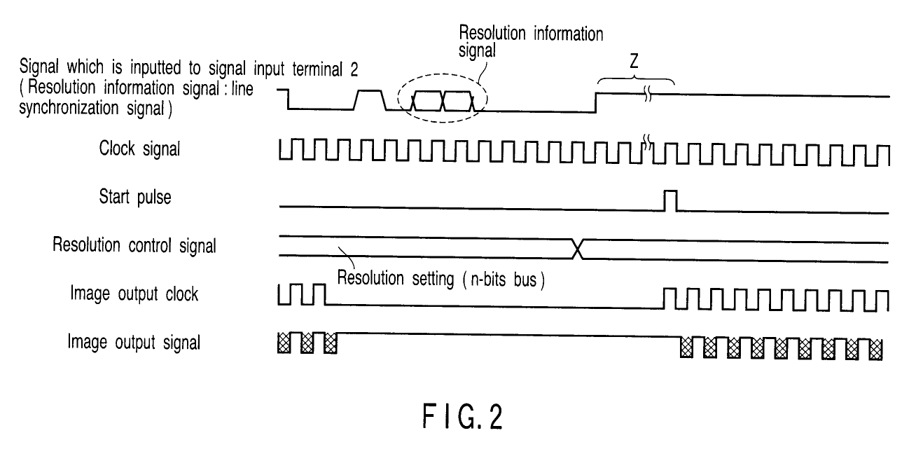

FIG. 2 is a timing chart showing one example of various signals handled by the image sensor module 1 according to the present embodiment. In the present embodiment, the line synchronization signal is active high.

The image sensor module 1 includes a signal input terminal 2, a clock signal input terminal 3, a signal generation unit 4, and photoelectric conversion devices (for example, sensor chips) 51 to 5m.

The signal input terminal 2 receives a line synchronization signal. The signal input terminal 2 also receives a resolution information signal when the line synchronization signal is negated.

The clock signal input terminal 3 receives a clock signal.

In the present embodiment, the clock signal is a basic signal whose pulse high and pulse low are switched in a fixed period. If, for example, assertion of the line synchronization signal is detected, the image sensor module 1 sequentially outputs image output signals from the corresponding photoelectric conversion devices 51 to 5m.

The signal generation unit 4 inputs the line synchronization signal from an external system via the signal input terminal 2. When the line synchronization signal is negated, the signal generation unit 4 inputs the resolution information signal via the signal input terminal 2. The signal generation unit 4 inputs the clock signal from an external system via the clock signal input terminal 3.

The signal generation unit 4 includes a line synchronization signal detection unit 41, a resolution information detection unit 42, a resolution control signal generation unit 43, a start pulse generation unit 44, and an image output clock generation unit 45, and generates and outputs a resolution control signal, a start pulse, a resolution control signal, and an image output clock based on the line synchronization signal, resolution information signal, and clock signal.

The line synchronization signal detection unit 41 detects whether the line synchronization signal is negated or asserted based on a signal which is inputted from the signal input terminal 2 and the clock signal.

If assertion of the line synchronization signal is detected by the line synchronization signal detection unit 41, the resolution information detection unit 42 becomes a resolution information signal waiting state to detect the resolution information signal of a predetermined length which is inputted from the signal input terminal 2.

The resolution control signal generation unit 43 generates the resolution control signal for setting the photoelectric conversion devices 51 to 5m to the resolution indicated by the resolution information signal detected by the resolution information detection unit 42 and outputs the resolution control signal to the photoelectric conversion devices 51 to 5m.

If, for example, assertion of the line synchronization signal is detected by the line synchronization signal detection unit 41, the start pulse generation unit 44 generates the start pulse indicating a start by extracting one clock of the clock signal and outputs the start pulse, among the photoelectric conversion devices 51 to 5m, to a first photoelectric conversion device 51 that first outputs the image output signal.

If, for example, assertion of the line synchronization signal is detected by the line synchronization signal detection unit 41, the image output clock generation unit 45 generates the image output clock for the photoelectric conversion devices 51 to 5m based on the clock signal and outputs the image output clock to the photoelectric conversion devices 51 to 5m.

The resolution of the photoelectric conversion devices 51 to 5m is set in accordance with the resolution control signal.

If, after a start pulse is input, the image output clock is high, the first photoelectric conversion device 51 outputs an image output signal held by the first photoelectric conversion device 51 to an external system and outputs a switching signal to the next photoelectric conversion device 52.

If after switching signal from the previous photoelectric conversion device 51 is input, the image output clock is high, the photoelectric conversion device 52 outputs an image output signal held by the photoelectric conversion device 52 and outputs a switching signal to the next photoelectric conversion device 53.

The same operation as that of the photoelectric conversion device 52 is sequentially performed from the photoelectric conversion device 53 to the photoelectric conversion device 5m-1.

If, after the switching signal from the previous photoelectric conversion device 5m-1 is input, the image output clock is high, the last photoelectric conversion device 5m outputs an image output signal held by the photoelectric conversion device 5m.

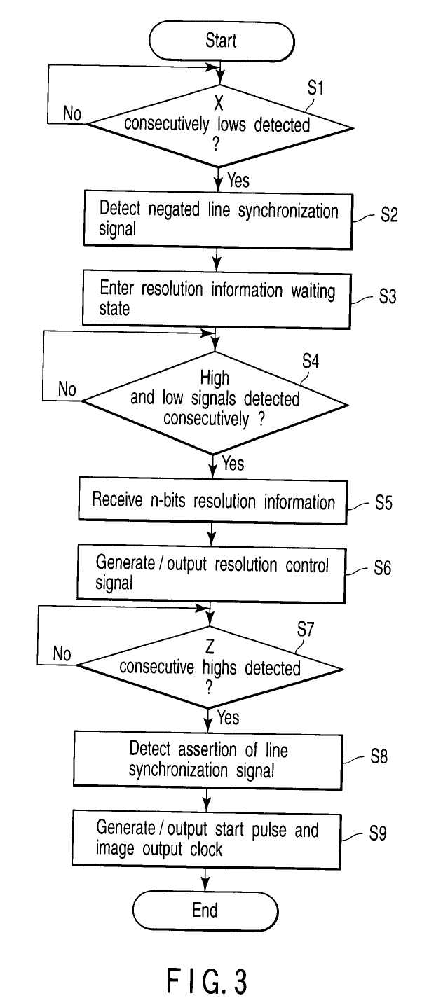

FIG. 3 is a flowchart showing one example of the operation of the signal generation unit 4 in the image sensor module 1 according to the present embodiment.

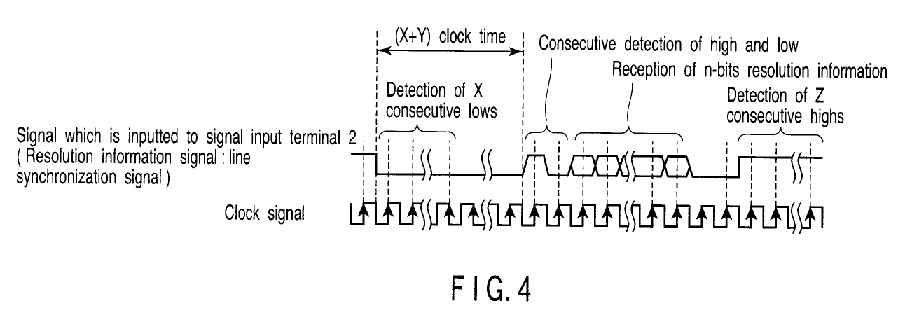

FIG. 4 is a timing chart showing one example of relationship among the resolution information signal, line synchronization signal, and clock signal.

In FIGS. 3 and 4, X, Y, Z, and n are preset integers.

In step S1, the line synchronization signal detection unit 41 samples the signal which is inputted from the signal input terminal 2 using the input clock to execute a signal detecting. Then, the line synchronization signal detection unit 41 determines whether the low signal has been input from the signal input terminal 2 X times consecutively.

If the low signal has not been input X times consecutively, the waiting state is entered until the low signal is input from the signal input terminal 2 X times consecutively.

If the low signal has been input from the signal input terminal 2 X times consecutively, in step S2, the line synchronization signal detection unit 41 detects negation of the line synchronization signal.

After the line synchronization signal is negated, an external system transmits high and low signals consecutively to cause the signal generation unit to receive the resolution information in synchronization with the clock after an (X+Y) clock time passes and then continues to transmit a n-bits resolution information signal.

In step S3, the resolution information detection unit 42 enters the waiting state of the resolution information after the line synchronization signal is negated.

In step S4, the resolution information detection unit 42 determines whether high and low signals have consecutively been input from the signal input terminal 2.

If the high and low signals have not been input consecutively, the waiting state is entered until the high and low signals are input consecutively from the signal input terminal 2.

If the High and Low signals have been input consecutively from the signal input terminal 2, in step S5, the resolution information detection unit 42 detects the head of n-bits serial data from the signal input terminal and then continues to receive resolution information.

In step S6, the resolution control signal generation unit 43 generates the resolution control signal for setting the resolution of the photoelectric conversion devices 51 to 5m so that the resolution of the photoelectric conversion devices 51 to 5m becomes equal to the resolution indicated by the n-bits resolution information signal and outputs the resolution control signal to the photoelectric conversion devices 51 to 5m.

In step S7, the line synchronization signal detection unit 41 enters the waiting state of assertion of the line synchronization signal and samples the signal which is inputted from the signal input terminal 2 using the input clock to execute a signal detecting.

Then, the line synchronization signal detection unit 41 determines whether the high signal has been input from the signal input terminal 2 Z times consecutively. is If the high signal has not been input Z times consecutively, the waiting state is entered until the high signal is input from the signal input terminal 2 Z times consecutively.

If the high signal has been input from the signal input terminal 2 Z times consecutively, in step S8, the line synchronization signal detection unit 41 detects assertion of a line synchronization signal.

In step S9, the start pulse generation unit 44 outputs the start pulse generated based on the clock signal to the first photoelectric conversion device 51 and the image output clock generation unit 45 outputs the image output clock to the photoelectric conversion devices 51 to 5m.

In the present embodiment described above, there is no need to comprise a terminal for inputting the resolution information signal and it is possible to provide the inexpensive and small image sensor module 1 while realizing a multi-resolution switching function that can support speed enhancement.

That is, in the present embodiment, the resolution can be switched even if there is no input terminal of resolution information signal and therefore, it becomes possible to reduce the number of terminals of the image sensor module 1 and make the image sensor module 1 cheaper and smaller.

In the present embodiment, miniaturization of the device and cost reduction can be implemented by constructing the signal generation unit 4 and the photoelectric conversion devices 51 to 5m separately.

Since the signal generation unit 4 can be configured as a logic circuit in the present embodiment, the signal generation unit 4 can be manufactured easily and inexpensively in the same process as a process of a logic LSI and the process can easily be optimized.

Further, in the present embodiment, the configuration of an external system can be prevented from becoming more complicated.

### Second Embodiment

In the present embodiment, the same numerals denote the same parts as those described in the aforementioned first embodiment to omit descriptions thereof or describe them briefly, and here different parts will be described in detail.

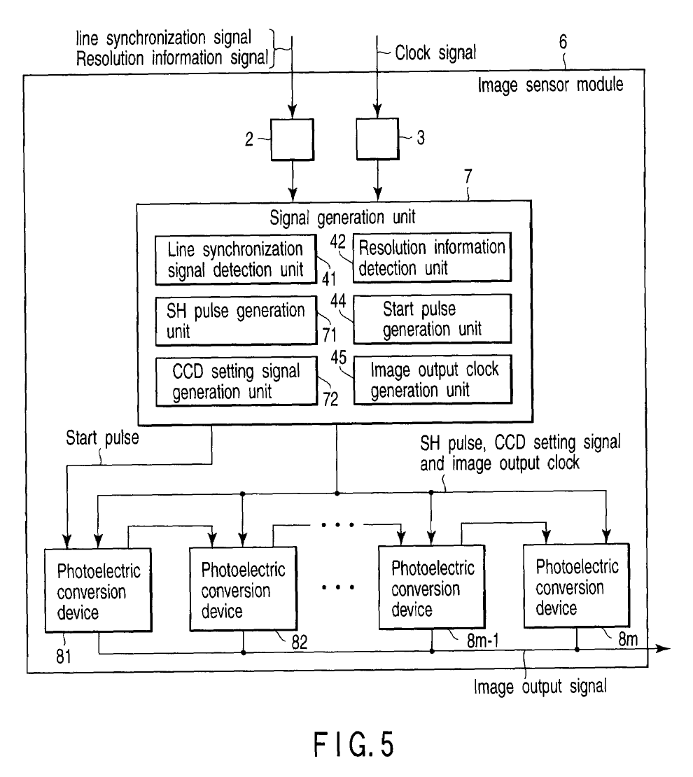

FIG. 5 is a block diagram showing one example of the configuration of an image sensor module according to the present embodiment. An image sensor module 6 is, for example, a contact image sensor module of CCD type.

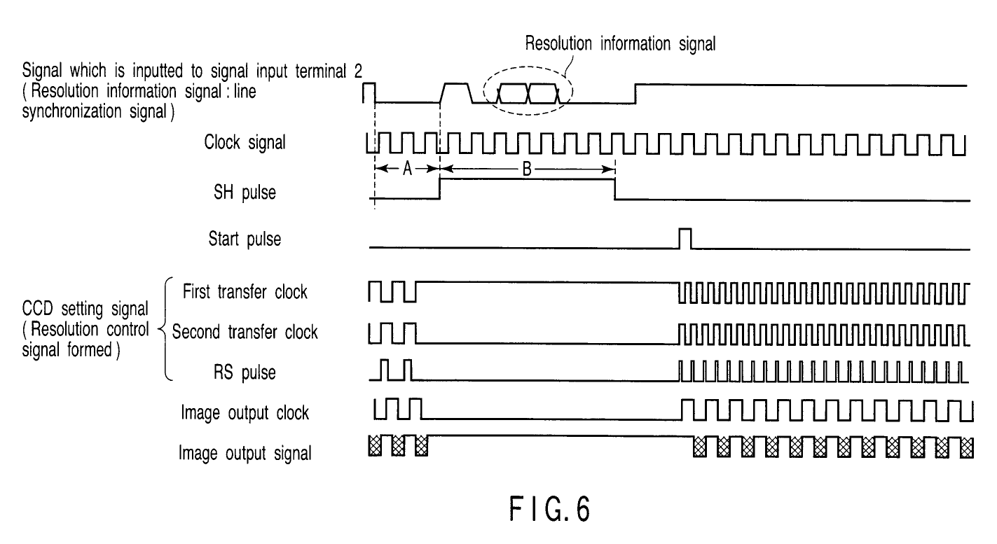

FIG. 6 is a timing chart showing one example of various signals handled by the image sensor module 6 according to the present embodiment.

The image sensor module 6 comprises a signal input terminal 2, a clock signal input terminal 3, a signal generation unit 7, and photoelectric conversion devices 81 to 8m.

The signal generation unit 7 inputs the line synchronization signal input from an external system via the signal input terminal 2 and, when the line synchronization signal is negated, inputs the resolution information signal. The signal generation unit 7 inputs the clock signal from an external system via the clock signal input terminal 3.

The signal generation unit 7 comprises the line synchronization signal detection unit 41, the resolution information detection unit 42, the start pulse generation unit 44, the image output clock generation unit 45, an SH pulse generation unit 71, and a CCD setting signal generation unit 72, and generates and outputs an SH pulse, the start pulse, a CCD setting signal, and the image output clock based on the line synchronization signal, resolution information signal, and clock signal.

In the present embodiment, the SH pulse, start pulse, CCD setting signal, and image output clock are signals necessary for CCD driving. The resolution of the photoelectric conversion devices 81 to 8m can be switched in the present embodiment by switching the state of the CCD setting signal. That is, in the present embodiment, the CCD setting signal including a first transfer clock, a second transfer clock, and an RS pulse forms a resolution control signal for controlling the resolution of the photoelectric conversion devices 81 to 8m.

The SH pulse generation unit 71 generates the SH pulse based on the line synchronization signal detected by the line synchronization signal detection unit 41 and the clock signal and outputs the SH pulse to the photoelectric conversion devices 81 to 8m. If, for example, the line synchronization signal changes from high to low and then A clocks are counted, the SH pulse generation unit 71 changes the SH pulse from low to high and, if B clocks are further counted, changes the SH pulse from high to low. The SH pulse indicates timing for transferring charges from a photodiode to a shift register.

If assertion of a line synchronization signal is detected by the line synchronization signal detection unit 41, the CCD setting signal generation unit 72 generates a CCD setting signal based on the clock signal and outputs the CCD setting signal to the photoelectric conversion devices 81 to 8m. For example, the CCD setting signal generation unit 72 generates the first transfer clock, the second transfer clock, and the RS pulse and outputs the first transfer clock, second transfer clock, and RS pulse to the photoelectric conversion devices 81 to 8m. For example, the first transfer clock, second transfer clock, and RS pulse are generated by the CCD setting signal generation unit 72 using “a technique by which a delayed clock signal obtained by delaying the clock signal by a delay device is generated in accordance with the resolution information signal detected by the resolution information detection unit 42 and a logical product of the clock signal and delayed clock signal is determined in a state in which assertion of a line synchronization signal is detected by the line synchronization signal detection unit 41 or the like.”

In the present embodiment, the first transfer clock, second transfer clock, and RS pulse are generated in accordance with the resolution indicated by the resolution information signal. The resolution of the photoelectric conversion devices 81 to 8m is set by, for example, the pulse width and timing of the first transfer clock, second transfer clock and the RS pulse.

The photoelectric conversion devices 81 to 8m output image output signals in order of the photoelectric conversion device 81 to the photoelectric conversion device 8m according to the start pulse, switching signal, and image output clock.

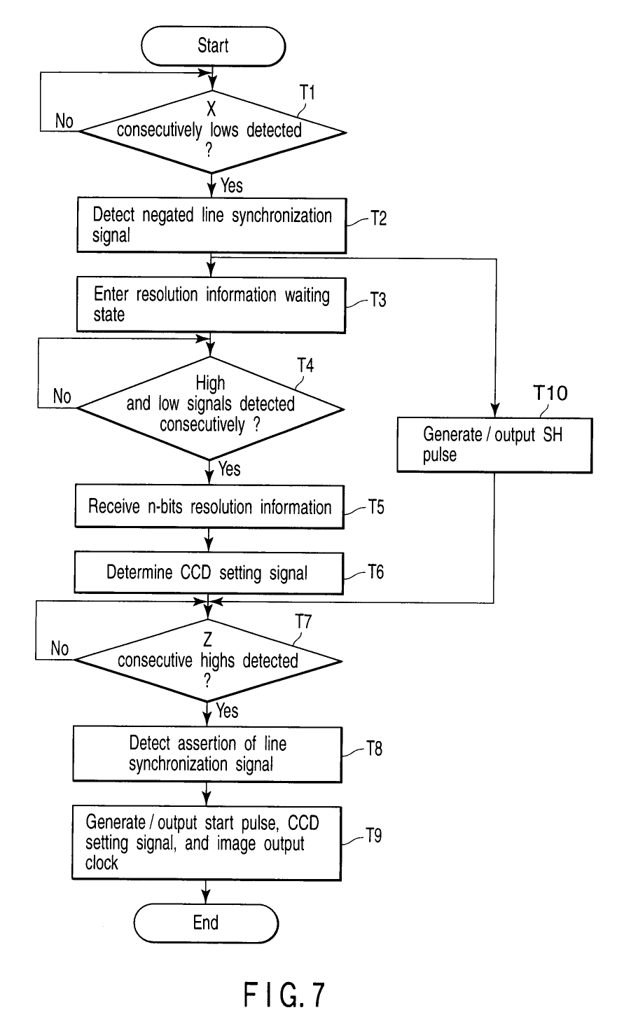

FIG. 7 is a flowchart showing one example of the operation of the signal generation unit 7 of the image sensor module 6 according to the present embodiment.

Step T1 to step T5 are the same as step S1 to step S5 according to the first embodiment.

In step T6, the CCD setting signal generation unit 72 determines the CCD setting signal for setting the resolution of the photoelectric conversion devices 81 to 8m so that the resolution becomes equal to the resolution indicated by the n-bits resolution information signal.

Also in the present embodiment, the SH pulse generation unit 71 generates the SH pulse at any moment between the time when negation of a line synchronization signal is detected and the time when assertion thereof is detected, that is, after step T2 and before completion of step T6, and outputs the SH pulse to the photoelectric conversion devices 81 to 8m (step T10).

Step T7 and step T8 are the same as step S7 and step S8 according to the first embodiment.

In step T9, the start pulse generation unit 44 outputs the start pulse generated based on the clock signal to the first photoelectric conversion device 51, the CCD setting signal generation unit 72 output a CCD setting signal in a determined state to the photoelectric conversion devices 81 to 8m, and the image output clock generation unit 45 outputs an image output clock to the photoelectric conversion devices 81 to 8m.

In the present embodiment described above, there is no need for comprising a terminal for inputting the resolution information signal and it is possible to provide the inexpensive and small image sensor module 6 of the CCD type while realizing a multi-resolution switching function that can support speed enhancement. Moreover, miniaturization of the device and cost reduction can be implemented by constructing the signal generation unit 7 and the photoelectric conversion devices 81 to 8m separately.

Further, the signal generation unit 7 can all be constructed from a logic circuit and clock multiplying circuit such as PLL and therefore, can be easily and inexpensively manufactured in the same process as the process of a logic LSI and the process can easily be optimized.

Further, in the present embodiment, the configuration of an external system can be prevented from becoming more complicated.

What is claimed is:

1. An image sensor module comprising:
a plurality of photoelectric conversion devices;
a signal input terminal to input a line synchronization signal and input a resolution information signal;
a clock signal input terminal to input a clock signal;
a resolution information detection unit which detects the resolution information signal from a signal which is inputted from the signal input terminal based on the clock signal; and
a resolution control signal generation unit which generates a resolution control signal for setting a resolution indicated by the resolution information signal detected by the resolution information detection unit and outputs the resolution control signal to the photoelectric conversion devices.

2. An image sensor module according to claim 1, further comprising:
a line synchronization signal detection unit which detects whether the line synchronization signal is negated or asserted based on the signal which is inputted from the signal input terminal and the clock signal;
a start pulse generation unit which generates a start pulse based on the clock signal and outputs the start pulse to a first photoelectric conversion device being included the photoelectric conversion devices, when assertion of the line synchronization signal is detected by the line synchronization signal detection unit; and
an image output clock generation unit which generates an image output clock and outputs the image output clock to the photoelectric conversion devices when assertion of the line synchronization signal is detected by the line synchronization signal detection unit,
wherein the resolution information detection unit detects a resolution information signal of a predetermined length input from the signal input terminal when negation of the line synchronization signal is detected by the line synchronization signal detection unit, and
a signal generation unit including the line synchronization signal detection unit, the resolution information detection unit, the resolution control signal generation unit, the start pulse generation unit, and the image output clock generation unit is constructed separately from the photoelectric conversion devices.

3. An image sensor module according to claim 1, wherein the photoelectric conversion devices are sensor chips of CMOS type.

4. An image sensor module according to claim 1, wherein the photoelectric conversion devices are sensor chips of CCD type.

5. An image sensor module according to claim 4, wherein the resolution control signal generation unit is a CCD setting signal generation unit, and the resolution control signal is a CCD setting signal.

6. An image sensor module according to claim 5, further comprising:
a line synchronization signal detection unit which detects whether the line synchronization signal is negated or asserted based on the signal which is inputted from the signal input terminal and the clock signal;
a start pulse generation unit which generates a start pulse based on the clock signal and outputs the start pulse to a first photoelectric conversion device being included the photoelectric conversion devices when assertion of the line synchronization signal is detected by the line synchronization signal detection unit; and
an image output clock generation unit which generates an image output clock and outputs the image output clock to the photoelectric conversion devices when assertion of the line synchronization signal is detected by the line synchronization signal detection unit,
wherein the CCD setting signal unit
generates a delayed clock signal obtained by delaying the clock signal by a delay device in accordance with the resolution information signal detected by the resolution information detection unit, and
generates the CCD setting signal by determining a logical product of the clock signal and the delayed clock signal in a state in which assertion of the line synchronization signal is detected by the line synchronization signal detection unit.

7. An image sensor module according to claim 5, wherein the CCD setting signal is set based on a state of a pulse width or timing in accordance with the resolution indicated by the resolution information signal.

8. A signal generation device comprising:
a signal input terminal to input a line synchronization signal and input a resolution information signal;
a clock signal input terminal to input a clock signal;
a resolution information detection unit which detects the resolution information signal from a signal which is inputted from the signal input terminal based on the clock signal; and
a resolution control signal generation unit which generates a resolution control signal for setting a resolution indicated by the resolution information signal detected by the resolution information detection unit and outputs the resolution control signal to a plurality of photoelectric conversion devices.

9. A signal generation device according to claim 8, which is constructed separately from the photoelectric conversion devices and further comprising:
a line synchronization signal detection unit which detects whether the line synchronization signal is negated or asserted based on the signal which is inputted from the signal input terminal and the clock signal;
a start pulse generation unit which generates a start pulse based on the clock signal and outputs the start pulse to a first photoelectric conversion device being included the photoelectric conversion devices, when assertion of the line synchronization signal is detected by the line synchronization signal detection unit; and
an image output clock generation unit which generates an image output clock and outputs the image output clock to the photoelectric conversion devices when assertion of the line synchronization signal is detected by the line synchronization signal detection unit,
wherein the resolution information detection unit detects a resolution information signal of a predetermined length input from the signal input terminal when negation of the line synchronization signal is detected by the line synchronization signal detection unit.

10. A signal generation device according to claim 8, wherein the photoelectric conversion devices are sensor chips of CMOS type, and the resolution control signal is output to the sensor chips of the CMOS type.

11. A signal generation device according to claim 8, wherein the photoelectric conversion devices are sensor chips of CCD type, and the resolution control signal is output to the sensor chips of the CCD type.

12. A signal generation device according to claim 11, wherein the resolution control signal generation unit is a CCD setting signal generation unit, and
the resolution control signal is a CCD setting signal.

13. A signal generation device according to claim 12, further comprising:
a line synchronization signal detection unit which detects whether the line synchronization signal is negated or asserted based on the signal which is inputted from the signal input terminal and the clock signal;
a start pulse generation unit which generates a start pulse based on the clock signal and outputs the start pulse to a first photoelectric conversion device being included the photoelectric conversion devices when assertion of the line synchronization signal is detected by the line synchronization signal detection unit; and
an image output clock generation unit which generates an image output clock and outputs the image output clock to the photoelectric conversion devices when assertion of the line synchronization signal is detected by the line synchronization signal detection unit,
wherein the CCD setting signal unit
generates a delayed clock signal obtained by delaying the clock signal by a delay device in accordance with the resolution information signal detected by the resolution information detection unit, and
generates the CCD setting signal by determining a logical product of the clock signal and the delayed clock signal in a state in which assertion of the line synchronization signal is detected by the line synchronization signal detection unit.

14. A signal generation device according to claim 12, wherein the CCD setting signal is set based on a state of a pulse width or timing in accordance with the resolution indicated by the resolution information signal.

15. A signal generation method comprising:
detecting negation of a line synchronization signal from a signal which is inputted from a signal input terminal based on a clock signal;
detecting resolution information from the signal which is inputted from the signal input terminal when the line synchronization signal is negated;
generating a resolution control signal for setting a resolution of a plurality of photoelectric conversion devices so that the resolution of photoelectric conversion devices becomes equal to a resolution indicated by the resolution information; and
outputting the resolution control signal to the photoelectric conversion devices.

16. A signal generation method according to claim 15, further comprising:
detecting assertion of the line synchronization signal from the signal which is inputted from the signal input terminal based on the clock signal when the resolution information is detected;
generating a start pulse based on the clock signal when assertion of the line synchronization signal is detected;
outputting the start pulse to a first photoelectric conversion device being included the photoelectric conversion devices;
generating an image output clock for the photoelectric conversion devices; and
outputting image output clock to the photoelectric conversion devices.

17. A signal generation method according to claim 15, wherein the resolution control signal is formed by a CCD setting signal.

18. A signal generation method according to claim 17, further comprising:
generating a SH pulse at any moment between the time when negation of the line synchronization signal is detected and the time when assertion of the line synchronization signal is detected;
outputting the SH pulse to the photoelectric conversion devices;
detecting assertion of the line synchronization signal from the signal which is inputted from the signal input terminal based on the clock signal when the resolution information is detected;
generating a start pulse based on the clock signal when assertion of the line synchronization signal is detected;
outputting the start pulse to a first photoelectric conversion device being included the photoelectric conversion devices;
generating an image output clock for the photoelectric conversion devices; and
outputting image output clock to the photoelectric conversion devices.
